(19) United States
(12) Patent Application Publication
(10) Pub. No.: US 2010/0231671 A1
(43) Pub. Date: Sep. 16, 2010

(54) PRETREATMENT FOR LOW AND NON-POROUS MEDIA FOR INKJET PRINTING

(75) Inventors: Waifong Liew Anton, Wilmington, DE (US); Scott W. Ellis, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/599,081

(22) PCT Filed: Jun. 4, 2008
(86) PCT No.: PCT/US08/65699

§ 371 Date: Nov. 6, 2009

Related U.S. Application Data
(60) Provisional application No. 60/933,010, filed on Jun. 4, 2007.

(51) Int. Cl. B41J 2/01

(52) U.S. Cl. 347/101

(57) ABSTRACT

This invention pertains to inkjet printing on non-porous or low porous media and to a pretreatment solution for the non-porous or low porous media that allows high quality printing thereon. The preferred digitally printed inks are disperse dye or pigmented inks.

### BACKGROUND OF THE INVENTION

This invention pertains to inkjet printing on a non-porous or low porous media with aqueous inkjet inks, and to a pretreatment solution for the non-porous media that allows high quality printing thereon. The colorants in the inkjet inks are disperse dyes or pigments.

Digital printing methods such as inkjet printing with aqueous inks are becoming important for the printing of solid surfaces, i.e., non-porous or low porous media, and offer a number of potential benefits over conventional printing methods such as transfer printing, screen printing, also ink jet printing with UV curable and solvent based inks. With regard to inkjet printing, aqueous inkjet inks are inherently safer than reactive UV inks and inks whose primary vehicle is a solvent. Inkjet printing furthermore allows visual effects such as tonal gradients that cannot be practically achieved with the other printing means for solid surfaces. Examples of solid surfaces that can be printed include signage, trophies and plaques, golf balls, polymeric sheets used for interlayers, and offset paper.

Both dyes and pigments have been used as colorants for inkjet inks and both have certain advantages. Pigment and disperse dye inks are advantageous because they tend to provide more water-fast and light-fast images than soluble dye inks. However, aqueous pigment and disperse dye inks are not easily adhered to solid surfaces. Although current pigment and disperse dye inks are being successfully jetted onto solid surfaces, there is still a need in the art for, and it is an object of this invention to provide, such an inkjet ink with adequate adhesion to solid surfaces that still retains other beneficial print properties. The printed image then can be overcoated to improve the durability of the printed image.

U.S. Pat. No. 6,084,619 describes an ink jet recording method where a polyvalent metal salt is jetted unto a recording medium along with a pigmented ink which has a resin emulsion present.

U.S. Pat. No. 6,426,375 describes an ink jet recording method where a reaction solution causes an ink composition to produce a coagulate. The ink is a pigmented ink and contains a resin emulsion with a minimum film-forming temperature of 20° C. or below.

U.S. Pat. No. 6,833,008 describes a surface treatment for printing water based inks, where the surface treatment has a polyvalent metallic salt and at least one of a polymer swelling reagent and a coalescence reagent. The polymer swelling agent and/or the coalescence reagent apparently penetrates the printing media surface to facilitate penetration of the colorants from the water based inks.

US2007/0056118 describes the use of a pretreatment for a textile. The pretreatment solution consists of a multivalent salt solution.

US2007/0067928 describes the use of a pretreatment for a textile. The pretreatment solution consists of a multivalent salt solution and a nonionic latex polymer which has sufficient nonionic components such that the nonionic latex polymer is stable in the presence of the multivalent cationic salt solution.

While digital printing provides a breadth of available printing conditions for almost any substrate, there is often a need for achieving a higher color on the solid surface. It is an object of this invention to enable higher color, high quality inkjet printing of non-porous or low porous media such as plastics, metals, glass, stone, wood, brick, and tile with disperse dye and pigmented inkjet inks.

### SUMMARY OF THE INVENTION

In one aspect, the present invention relates to a method of digitally printing a non-porous or low porous media comprising the steps of:
(a) pretreating the non-porous or low porous media with a pretreatment solution comprising an aqueous multivalent cationic salt solution and a surfactant,
(b) optionally, drying the pretreated low porous media,
(c) digitally printing pretreated non-porous or low porous media with a pigmented ink jet ink,
(d) where the pretreatment solution has substantially no organic species other than the surfactant and
(e) the surface tension of the pretreatment solution is about 15 dynes/cm to about 33 dynes/cm.

The present invention pertains, in another aspect, to a non-porous or low porous media that has been pretreated with an aqueous multivalent cationic salt and a surfactant solution, wherein the multivalent cationic salt is a calcium salt and the surfactant is selected from the group consisting of fluoro surfactants and siloxane surfactants and mixtures thereof. The pretreatment solution preferably has insignificant amounts (i.e., is substantially free) of other added organic compounds.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references to in the singular may also include the plural (for example, “a” and “an” may refer to one, or one or more) unless the context specifically states otherwise.

### DETAILED DESCRIPTION OF THE PREFERRED EMBODIMENTS

### Pretreatment Solution

The pretreatment solution used in the method of the present invention is an aqueous multivalent cationic salt and a surfactant solution. More preferably, the pretreatment solution comprises a solution of a multivalent cationic salt and a surfactant in water. Other organic ingredients such as cosolvents, swelling agents, coalescing agents, viscosity modifiers, preferably, will not be included in the pretreatment solution. The surfactant may be available with cosolvents present. Ingredient percentages of the multivalent cation and the surfactant herein are weight percent based on the total weight of the final solution, unless otherwise indicated. Unless otherwise indicated the weight of the multivalent cation is as commonly available and may include waters of hydration.

It was unexpectedly found that the combination of a multivalent salt and a surfactant in an aqueous pretreatment solution, especially a fluoro or siloxane surfactant, without any other organic additives could produce a balance of performance for printing on low porous media. This balance of performance cannot be achieved with other known pretreatment systems.

### Multivalent Cation

The pretreatments of this invention comprise one or more multivalent cations. The effective amounts needed in a particular situation can vary, and some adjustment, as provided for herein, will generally be necessary.

“Multivalent” indicates an oxidation state of two or more and, for an element “Z”, are typically described as Z²⁺, Z³⁺, Z⁴⁺ and so forth. For brevity, multivalent cations may be referred to herein as Z^{x}. The multivalent cations are substantially soluble in the aqueous pretreatment solution and preferably exist (in solution) in a substantially ionized state so that they are in a form where they are free and available to interact with non-porous or low porous media when the media is exposed to the pretreatment solution.

Z^{x} includes, but is not limited to multivalent cations of the following elements: Mg, Ca, Sr, Ba, Sc, Y, La, Ti, Zr, V, Cr, Mn, Fe, Ru, Co, Rh, Ni, Pd, Pt, Cu, Au, Zn, Al, Ga, In, Sb, Bi, Ge, Sn, Pb. In another embodiment, the multivalent cation comprises at least one of Ca, Ba, Ru, Co, Zn and Ga. In yet another embodiment, the multivalent cation comprises at least one of Ca, Ba, Ru, Co, Zn and Ga. Preferably the multivalent cation is Ca.

Z^{x} can be incorporated into pretreatment solution by addition in a salt form or by addition in an alkaline form and used as a base in the adjustment of the pretreatment solution pH.

The associated anionic material can be chosen from any common anionic material, especially halides, nitrates and sulfates. The anionic form is chosen so that the multivalent cation is soluble in the aqueous pretreatment solution. The multivalent cationic salts can be used in their hydrated form.

For Ca, the preferred multivalent cation salts are calcium chloride, calcium nitrate, calcium nitrate hydrate and mixtures thereof.

The solution should comprise sufficient multivalent cation content and surfactant to provide adequate coating of the non-porous or low porous media with the multivalent cation. Typically, the pretreatment will comprise at least about 5 wt % of the multivalent cation salt, and amounts can be used up to the solubility limits of the particularly multivalent cation salt or salts utilized. Preferably, the pretreatment will comprise from about 8 wt % to about 70 wt % of the multivalent cation salt and more preferably up to about 45 wt %. The weight basis of the multivalent cation salt is as the total weight of multivalent cation including waters of hydration. To illustrate when a 15% solution of calcium chloride is reported this is the weight of the calcium chloride dehydrate added to the solution. In this case the net weight of the calcium for the 15% solution is 4.1%.

### Surfactant

The surfactant can be any surfactant that lowers the surface tension of the multivalent salt solution to about 15 to about 33 dynes/cm or preferably about 18 to about 30 dynes/cm. The amount of surfactant is from about 0.05 wt % to about 10 wt %, preferably from about 0.25 to about 8 wt % and more preferably 0.5 to 6 wt %. The weight of the surfactant is the as received weight from the commercial supplier and may contain some organic solvent components and/or water. The weight is the total weight of the surfactant which includes water and/or other solvents in the as received surfactant material. The surfactant must also be stable to the high salt concentration.

While not being bound by theory it is believed that the surfactant facilitates even distribution of the multivalent salt on the surface of the non-porous or low porous media. The even distribution leads to excellent color in the printed image; little if any bleed between the ink components; and sufficient adhesion for the printed image to be retained on the surface of the non-porous or low porous media.

While any surfactant that meets the surface tension limitations and the salt stability can be chosen, alternatively the surfactant can be chosen from surfactants that have strong reduction of surface tension. Examples of these types of surfactants include fluorosurfactants and siloxane surfactants. Non-limiting examples of the fluorosurfactants include Zonyl ®Fluorosurfactants supplied by E.I. du Pont de Nemours and Company, (Wilmington Del.) and Fluorad® surfactants supplied by 3M Company, (Minneapolis Minn.). See U.S. Pat. No. 5,852,075 (column 6 line 43 to column 7 line 30) for a further description of candidate fluoro surfactants for the inventive pretreatment solution, the disclosure of which is incorporated by reference herein for all purposes as if fully set forth.

Another example of surfactants that have strong reduction in surface tension are siloxane surfactants. An alternate description of this type of surfactant is a siloxane surfactant. See U.S. Pat. No. 5,852,075 (column 4 line 41 to column 6 line 32) for a description of candidate siloxane surfactants for the inventive pretreatment solution, the disclosure of which is incorporated by reference herein for all purposes as if fully set forth. Examples of commercially available siloxane surfactants include BYKs and Silwets from BykChemie, Wallingford Conn. and Momentive Performance Materials, Wilton Conn. respectively.

Another candidate class of surfactants include sulfonated surfactants and nonionic surfactants which are stable to the high salt content of the pretreatment solution. These include but are not limited to alkali metal and ammonium salts of ethoxylated alkyl sulfates; alkali metal salts and ammonium salts of alky sulfates, alkyl aryl sulfonates, alkylated benzene sulfonates; alkali metal and ammonium salts of ethoxylated straight chain primary and aliphatic secondary alcohols; amphoteric surfactants and nonionic surfactants such as ethoxylated alkylphenols, alkanol amides and amine oxides.

### Other Components of the Pretreatment Solution

The balance of the pretreatment solution is water. A pretreatment solution consisting essentially of a solution of a multivalent cationic salt and surfactant in water is particularly suitable. The pretreatment solution is substantially free of other added organic components. The surfactant may be available as a concentrated mixture in organic solvents.

It is has been found that when other organic components are included in the pretreatment solution, the resulting image printed is not as good. The image is blotchy or non uniform, there is significantly more bleed between the colors, there is little or no adhesion to the low porous media.

While not being bound by theory the pretreatment solution, it is the purpose of the solution to spread itself evenly across the surface and when the at least partially drying of the non-porous or low porous media occurs the multivalent cation salt is still evenly distributed throughout the treated part of the surface. Water miscible solvents, penetrating agents, coalescing agents, viscosity agents all interfere with the pretreatment solution effectiveness.

Up to 5 weight % of organic solvents may be included in the pretreatment solution especially solvents that are part of the available surfactant as they do not interfere with the function of the pretreatment solution. If included as part of the surfactant, only up to about 2 weight ° A) of organic solvents is generally preferred.

### Pretreatment of the Non-Porous or Low Porous Media

Non-porous or low porous media, commonly referred to as solid surfaces, are media which will not absorb, wick or be penetrated by significant amounts of the pretreatment solution or the aqueous inks described below. A non limiting list includes plastics, vinyl coated wall coatings, other polymeric/plastic sheets such as polyvinylbutyral, Tyvek® (DuPont's brand of spun-bonded olefin from high-density polyethylene), plastic sheets using, as a base material, polyethylene terephthalate, polycarbonate, polypropylene, polyethylene, polysulfone, ABS resin, and polyvinyl chloride; recording media prepared by coating a metal, for example, by vapor deposition, onto the surface of metals, such as brass, iron, aluminum, SUS, and copper, or non-metallic substrates; recording media prepared by subjecting paper as a substrate, for example, to water repellency-imparting treatment; recording media prepared by subjecting the surface of fibers, such as cloth, for example, to water repellency-imparting treatment; and recording media formed of the so-called “ceramic materials,” prepared by firing inorganic materials at a high temperature, metals, glass, stone, wood, brick, tile, transparencies and paper which is hydrophobic because it is either highly calendered and/or coated with hydrophilic coatings or paper which has been processed for commercial offset printing. Included in the non-porous or low porous media includes media that would not absorb any of the pretreatment solution or the aqueous inks. Another characteristic of the preferred media is that it has low surface energy.

The recording medium according to the present invention does not substantially absorb an ink composition or the pretreatment solution.

Application of the pretreatment to the non-porous or low porous media can be any convenient method and such methods are generally well-known in the art. One example is an application method referred to as padding. A draw down bar may be used to apply the pretreatment solution. Other pretreatment techniques include spray application wherein the solution is applied by spraying on the face or face and back of the low porous media. Spraying can be limited to the digitally printed area of the low porous media. An example of where this limited spraying would be particularly applicable is in the digital printing of an image on preformed non-porous or low porous media articles such as, for example, plexiglass trophies or plaques.

After application of pretreatment in the pretreatment step, the non-porous or low porous media may be dried in any convenient manner. The non-porous or low porous media is preferably substantially dry at the time of printing, such that the final percent moisture is (approximately) equal to the equilibrium moisture of the pretreated media at ambient temperature. The absolute amount of moisture in the low porous media, of course, can vary somewhat depending on the relative humidity of the surrounding air. An adequate drying condition is to put the solid non-porous or low porous media in a 70° C. heated oven for approximately 5 minutes.

The multivalent salts remaining on the non-porous or low porous media after drying provide an interactive material that will interact with the inkjet inks during printing. It will be appreciated that sufficient multivalent salts must be present to effect a brighter/more colorful image. Routine optimization will reveal appropriate multivalent salt levels for a given printer and disperse dye ink, pigmented ink, disperse dye ink set, or pigmented ink set.

### Disperse Dye and Pigmented InkJet Inks

Disperse dye and pigmented inkjet inks suitable for use in the present method typically comprise a pigment dispersed in a vehicle. The vehicle can be aqueous or non-aqueous, but aqueous vehicles are preferred. Preferably, the pigment ink comprises an anionically stabilized pigment dispersed in an aqueous vehicle. The disperse dye also comprises an anionically stabilized disperse dye in an aqueous vehicle.

An “aqueous vehicle” refers to a vehicle comprised of water or a mixture of water and at least one water-soluble organic solvent (co-solvent) or humectant. Selection of a suitable mixture depends on requirements of the specific application, such as desired surface tension and viscosity, the selected colorant, and compatibility with substrate onto which the ink will be printed.

Examples of water-soluble organic solvents and humectants include: alcohols, ketones, keto-alcohols, ethers and others, such as thiodiglycol, sulfolane, 2-pyrrolidone, 1,3-dimethyl-2-imidazolidinone and caprolactam; glycols such as ethylene glycol, diethylene glycol, triethylene glycol, tetraethylene glycol, propylene glycol, dipropylene glycol, tripropylene glycol, trimethylene glycol, butylene glycol and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, diethylene glycol monoethyl ether; lower dialkyl ethers of polyhydric alcohols, such as diethylene glycol dimethyl or diethyl ether; urea and substituted ureas.

An aqueous vehicle will typically contain about 30% to about 95% water with the balance (i.e., about 70% to about 5%) being the water-soluble solvent. Ink compositions typically contain about 60% to about 95% water, based on the total weight of the aqueous vehicle.

Pigments suitable for being used with the multivalent pretreatment of the non porous media are those generally well-known in the art for aqueous inkjet inks. Traditionally, pigments are stabilized by dispersing agents, such as polymeric dispersants or surfactants, to produce a stable dispersion of the pigment in the vehicle. More recently though, so-called “self-dispersible” or “self-dispersing” pigments (hereafter “SDP”) have been developed. As the name would imply, SDPs are dispersible in water without dispersants. Dispersed dyes are also considered pigments as they are insoluble in the aqueous inks used herein.

The dispersant or surface treatment applied to the pigment creates an anionic surface charge (“anionic pigment dispersion”). Preferably, that surface charge is imparted predominately by ionizable carboxylic acid (carboxylate) groups.

The pigments which are stabilized by added dispersing agents may be prepared by methods known in the art. It is generally desirable to make the stabilized pigment in a concentrated form. The stabilized pigment is first prepared by premixing the selected pigment(s) and polymeric dispersant(s) in an aqueous carrier medium (such as water and, optionally, a water-miscible solvent), and then dispersing or deflocculating the pigment. The dispersing step may be accomplished in a 2-roll mill, media mill, a horizontal mini mill, a ball mill, an attritor, or by passing the mixture through a plurality of nozzles within a liquid jet interaction chamber at a liquid pressure of at least 5,000 psi to produce a uniform dispersion of the pigment particles in the aqueous carrier medium (microfluidizer). Alternatively, the concentrates may be prepared by dry milling the polymeric dispersant and the pigment under pressure. The media for the media mill is chosen from commonly available media, including zirconia, YTZ and nylon. These various dispersion processes are in a general sense well known in the art, as exemplified by U.S. Pat. No. 5,022,592, U.S. Pat. No. 5,026,427, U.S. Pat. No. 5,310,778, U.S. Pat. No. 5,891,231, U.S. Pat. No. 5,976,232 and US20030089277. The disclosures of each of these publications are incorporated by reference herein for all purposes as if fully set forth. Preferred are 2-roll mill, media mill, and by passing the mixture through a plurality of nozzles within a liquid jet interaction chamber at a liquid pressure of at least 5,000 psi.

After the milling process is complete the pigment concentrate may be “let down” into an aqueous system. “Let down” refers to the dilution of the concentrate with mixing or dispersing, the intensity of the mixing/dispersing normally being determined by trial and error using routine methodology, and often being dependent on the combination of the polymeric dispersant, solvent and pigment.

The dispersant used to stabilize the pigment is preferably a polymeric dispersant. Either structured or random polymers may be used, although structured polymers are preferred for use as dispersants for reasons well known in the art. The term “structured polymer” means polymers having a block, branched or graft structure. Examples of structured polymers include AB or BAB block copolymers such as disclosed in U.S. Pat. No. 5,085,698; ABC block copolymers such as disclosed in EP-A-0556649; and graft polymers such as disclosed in U.S. Pat. No. 5,231,131. Other polymeric dispersants that can be used are described, for example, in U.S. Pat. No. 6,117,921, U.S. Pat. No. 6,262,152, U.S. Pat. No. 6,306,994 and U.S. Pat. No. 6,433,117. The disclosure of each of these publications is incorporated herein by reference for all purposes as if fully set forth.

Polymer dispersants suitable for use in the present invention comprise both hydrophobic and hydrophilic monomers. Some examples of hydrophobic monomers used in random polymers are methyl methacrylate, n-butyl methacrylate, 2-ethylhexyl methacrylate, benzyl methacrylate, 2-phenylethyl methacrylate and the corresponding acrylates. Examples of hydrophilic monomers are methacrylic acid, acrylic acid, dimethylaminoethyl(meth)acrylate and salts thereof. Also quaternary salts of dimethylaminoethyl(meth)acrylate may be employed.

A wide variety of organic and inorganic pigments, alone or in combination, may be selected to make the ink. The term “pigment” as used herein means an insoluble colorant. The pigment particles are sufficiently small to permit free flow of the ink through the inkjet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss. The range of useful particle size is typically about 0.005 micron to about 15 micron. Preferably, the pigment particle size should range from about 0.005 to about 5 micron and, most preferably, from about 0.005 to about 1 micron. The average particle size as measured by dynamic light scattering is less than about 500 nm, preferably less than about 300 nm.

The selected pigment(s) may be used in dry or wet form. For example, pigments are usually manufactured in aqueous media and the resulting pigment is obtained as water-wet presscake. In presscake form, the pigment is not agglomerated to the extent that it is in dry form. Thus, pigments in water-wet presscake form do not require as much deflocculation in the process of preparing the inks as pigments in dry form. Representative commercial dry pigments are listed in previously incorporated U.S. Pat. No. 5,085,698.

In the case of organic pigments, the ink may contain up to approximately 30%, preferably about 0.1 to about 25%, and more preferably about 0.25 to about 10%, pigment by weight based on the total ink weight. If an inorganic pigment is selected, the ink will tend to contain higher weight percentages of pigment than with comparable inks employing organic pigment, and may be as high as about 75% in some cases, since inorganic pigments generally have higher specific gravities than organic pigments.

Self-dispersed pigments can be used and are often advantageous over traditional dispersant stabilized pigments from the standpoint of greater stability and lower viscosity at the same pigment loading. This can provide greater formulation latitude in final ink.

SDPs, and particularly self-dispersing carbon black pigments, are disclosed in, for example, U.S. Pat. No. 2,439,442, U.S. Pat. No. 3,023,118, U.S. Pat. No. 3,279,935 and U.S. Pat. No. 3,347,632. Additional disclosures of SDPs, methods of making SDPs and/or aqueous inkjet inks formulated with SDP's can be found in, for example, U.S. Pat. No. 6,852,156.

Titanium dioxide is also an example of a pigment that can be used, and is potentially advantageous because it is white in color. Titanium dioxide can be difficult to disperse in an ink vehicle that is compatible with an ink jet printer system. Those dispersions and/or ink vehicles that provide inkjet stable titanium dioxide can be used with the multivalent cation pretreated non porous media.

In a preferred embodiment, a combination of a graft and block copolymers are used as co-dispersants for the titanium dioxide pigment, such as described in U.S. application Ser. No. 10/872,856 (filed Jun. 21, 2004), the disclosure of which is incorporated by reference herein for all purposes as if fully set forth. This combination of dispersants is effective in stabilizing titanium dioxide pigment slurries and, furthermore, provides enhanced stability in the ink formulations.

### Additives to the Ink

Other ingredients (additives) may be formulated into the inkjet ink, to the extent that such other ingredients do not interfere with the stability and jettablity of the finished ink, which may be readily determined by routine experimentation. Such other ingredients are in a general sense well known in the art.

Commonly, surfactants are added to the ink to adjust surface tension and wetting properties. Suitable surfactants include ethoxylated acetylene diols (e.g. Surfynols® series from Air Products), ethoxylated primary (e.g. Neodol® series from Shell and Tomadol® series from Tomah Products) and secondary (e.g. Tergitol® series from Union Carbide) alcohols, sulfosuccinates (e.g. Aerosol® series from Cytec), organosilicones (e.g. Silwet® series from Momentive Performance Materials, Wilton Conn.) and fluoro surfactants (e.g. Zonyl® series from DuPont). Surfactants are typically used in the amount of about 0.01 to about 5% and preferably about 0.2 to about 2%, based on the total weight of the ink. The criteria for selecting surfactants for the inks are different than the criteria for selecting the surfactant for the pretreatment solution.

Polymers may be added to the ink to improve durability. The polymers can be soluble in the vehicle or dispersed (e.g. “emulsion polymer” or “latex”), and can be ionic or nonionic and are often described as polymeric binders. Useful classes of polymers include acrylics, styrene-acrylics and polyurethanes. A particularly preferred binder additive is a crosslinked polyurethane as described in US20050182154, the disclosure of which is incorporated by reference herein for all purposes as if fully set forth.

Biocides may be used to inhibit growth of microorganisms. Buffers may be used to maintain pH. Buffers include, for example, tris(hydroxymethyl)-aminomethane (“Trizma” or “Tris”).

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′, N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

The components described above can be combined to make an ink in various proportions and combinations in order to achieve desired ink properties, as generally described above, and as generally recognized by those of ordinary skill in the art. Some experimentation may be necessary to optimize inks for a particular end use, but such optimization is generally within the ordinary skill in the art.

The amount of vehicle in an ink is typically in the range of about 70% to about 99.8%, and more typically about 80% to about 99%. Colorant is generally present in amounts up to about 10%. Percentages are weight percent of the total weight of ink.

Other ingredients (additives), when present, generally comprise less than about 15% by weight, based on the total weight of the ink. Surfactants, when added, are generally in the range of about 0.2 to about 3% by weight based on the total weight of the ink. Polymers can be added as needed, but will generally be less than about 15% by weight based on the total weight of the ink.

Drop velocity, separation length of the droplets, drop size and stream stability are greatly affected by the surface tension and the viscosity of the ink. Ink jet inks typically have a surface tension in the range of about 20 dyne/cm to about 70 dyne/cm at 25° C. Viscosity can be as high as 30 cP at 25° C., but is typically somewhat lower. The ink has physical properties are adjusted to the ejecting conditions and printhead design. The inks should have excellent storage stability for long periods so as not clog to a significant extent in an ink jet apparatus. Further, the ink should not corrode parts of the ink jet printing device it comes in contact with, and it should be essentially odorless and non-toxic. Preferred pH for the ink is in the range of from about 6.5 to about 8.

### Ink Sets

The term “ink set” refers to all the individual inks or other fluids an inkjet printer is equipped to jet.

In one preferred embodiment, the ink set comprises at least two differently colored disperse dye or pigmented inkjet inks, at least one of which is a white pigmented inkjet ink (W) as described above.

In another preferred embodiment, the ink set comprises at least three differently colored pigmented inkjet inks, wherein at least one is a cyan pigmented inkjet ink (C), at least one is a magenta pigmented inkjet ink (M), and at least one is a yellow pigmented inkjet ink (Y).

In addition to the colored inkjet inks just mentioned, it is also preferable to include a black pigmented inkjet ink (K) in the ink set.

In addition to the CMYKW inks mentioned above, the ink sets may contain additional differently colored inks, as well as different strength versions of the CMYKW and other inks.

For example, the inks sets of the present invention can comprise full-strength versions of one or more of the inks in the ink set, as well as “light” versions thereof.

Additional colors for the inkjet ink set include, for example, orange, violet, green, red and/or blue.

### Printing Method

The present method relates to digitally printing a pretreated low porous media, where the pretreated non-porous or low porous media may have been dried. Typically, this involves the following steps:

(1) providing an inkjet printer that is responsive to digital data signals;

(2) loading the printer with the non-porous or low porous media to be printed, in this case the pretreated non porous media;

(3) loading the printer with the above-mentioned inks or inkjet ink sets; and

(4) printing onto the media using the inkjet ink or inkjet ink set in response to the digital data signals.

After the printing the printed media may be heated to dry the printed image. The heating conditions depends on the media and its maximum temperature before melting, sagging or the like. A mild heating condition can be about 70° C. for about 15 minutes. A simple oven may be used for this post printing step.

The residual material from the pretreatment solution may be washed off of the printed media. This can be especially useful for media that is transparent. Media that is translucent, white, colored and the like may not require the post printing washing. Simple rinsing with water is sufficient to remove residual pretreatment solution.

The printed image may also be overcoated with typical overcoats for images. These include polyurethanes, acrylics, emulsion polymers, uv curable polymers and the like.

Printing can be accomplished by any inkjet printer equipped for handling and printing low porous media. Commercial printers include, for example, the Dupont™ Artistri™ 3210 and 2020 printers (Wilmington Del.), the Mimaki Tex. (Nagano, Japan) series of printers, US Screen Printing T-Shirt Printer (Tempe Ariz.) and a DTG printer from Impression Technology (Sydney, Australia).

As indicated above, a variety of inks and ink sets are available for use with these printers. Commercially available ink sets include, for example, DuPont™ Artistri™ D700, P700 and P5000 series inks.

The amount of ink laid down on the non-porous or low porous media can vary by printer model, by print mode (resolution) within a given printer and by the percent coverage need to achieve a given color. The preferred amount of ink in each drop is less than about 35 picoliters, preferably less than about 25 picoliters, and more preferably less than 15 picoliters. The amount of ink jetted that can be jetted onto a media is dependent on the media and the printer. For instance, for the DTG printer and transparencies a drop size of less than 10 picoliters produces the best printed image.

If, however, a white ink is used as a background for the digitally printed image, up to about six times more white ink may be used to obtain an enhanced final image. In such case, the white ink is initially printed onto the media in at least a portion of the area to be covered by the final image (the underprint portion), then the final image is printed at least over the underprint portion. Alternately, the white ink may be printed after the colored portion is printed. The sequence of printing the colored ink last could be useful for a transparent low porous media where the image can be viewed from the opposite side to the printed side.

The white ink can also be printed outside the boundaries of the final image (either as part of the initial background printing, subsequently as part of the image printing or after the image is printed), for example, to generate a small, imperceptible boundary to the image, making the image appear to have a distinct boundary.

The use of the white ink for printing a background for an image is particularly useful when printed onto colored (non-white) non porous media.

The following examples illustrate the invention without, however, being limited thereto.

### EXAMPLES

### Printing Conditions

The examples described below were done using an DTG printer from Impression Technology at 720 by 720 dpi and 4 picoliter drops. The prints were made on various solid substrates. The solid, non porous surface substrates used were golf balls, transparencies from 3M (Minneapolis Minn.), cases for CDs, clear plastic trophy or plaques, wood, porcelain tile, brick, metal, glass, and stone.

### Pretreatment Solutions

Reagent grade calcium chloride dihydrate (Aldrich) was mixed with deionized water until the calcium chloride was completely in solution. Comparative solutions include solutions which contain greater than 5% of organic species and Surfynol surfactants. The surface tension was measured with a Kruss tensiometer with a platinum plate at ambient temperature.

TABLE 1
Pretreatment Solution and Comparative Pretreatment
Solutions

| | |
|---|---|
| Pretreatment Solution 1 | |
| Calcium Chloride | 15% |
| BYK-348 | 1% |
| Water | 84% |
| Surface Tension | 22.2 dynes/cm |
| Comparative Pretreatment | |
| Solution 1 | |
| Magnesium Nitrate | 25% |
| TEGMBE | 10% |
| Glycerol | 10% |
| Water | 55% |
| Surface Tension | 34.2 dynes/cm |
| Comparative Pretreatment | |
| Solution 2 | |
| Calcium Nitrate | 5% |
| TEGMBE | 10% |
| Glycerol | 10% |
| Surfynol 465 | 1% |
| Water | 74% |
| Surface Tension | 31.65 dynes/cm |
| Comparative Pretreatment | |
| Solution 3 | |
| Calcium Nitrate | 15% |
| TEGMBE | 10% |
| Glycerol | 10% |
| Surfynol 465 | 1% |
| Water | 64% |
| Surface Tension | 30.78 dynes/cm |

Table Footnotes
TEGMBE is an abbreviation for triethylene glycol monobutyl ether
Surfynols are from Air Products, Allentown PA and are acetylenic surfactants.
Calcium chloride as calcium chloride dihydrate
Magnesium nitrate as magnesium nitrate hexahydrate
Calcium nitrate as calcium nitrate tetrahydrate

### Pigmented Inks

Pigmented Inks were used for testing the pretreatment solution.

Ink Example 1 has the following formulation shown in Table 1. This ink is a white ink that can be printed prior to printing other pigmented ink or at the same time.

TABLE 2
White Ink Example 1

| | | Wt % (based on total |
|---|---|---|
| Component | Source | weight of Ink) |
| Titanium Dioxide | TiPure ® R-746 | 10.0 (solids) |
| Slurry | | |
| Polymeric Binder | Crosslinked | 8.0 (solids) |
| | polyurethane PUD | |
| | EX2 in | |
| | US20050182154 | |
| Surfactant | Byk-348 (BykChemie) | 0.25 |
| Solvent | Ethylene Glycol | 24.0 |
| Solvent | Glycerol | 12.0 |
| Biocide | Proxel ® GXL (Avecia) | 0.2 |
| Water | | Bal. to 100% |

Table Footnotes
TiPure ® R-746 is a commercially available titanium dioxide dispersion (E.I. DuPont de Nemours, Wilmington DE), which is described as a 76.5 wt % (solids) titanium dioxide slurry with a hydrophilic acrylic copolymer as the dispersant. The titanium dioxide used in this slurry is described as being coated with 3% hydrous silica and 1.5-2.0% hydrous alumina, with a mean particle size of about 280 nm.

Where all of the weights are the net weights in the ink. For example, the polymeric binder is available as an emulsion in about a 33% weight percent solution in water. Thus about 24 grams of the polymeric binder emulsion is added to the ink formulation so that 8% polymeric binder is in the final ink.

Ink example 2 is a magenta ink and is based on pigment R122. The formulation is listed in Table 3.

TABLE 3
CMYK Ink Formulation

| | | Wt % | Wt % | Wt % | Wt % |
|---|---|---|---|---|---|
| | | Black | Cyan | Magenta | Yellow |
| Component | Source | Ink | Ink | Ink | Ink |
| Polymeric | Crosslinked | 4.70% | 4.50% | 5.00% | 4.30% |
| Binder | polyurethane | | | | |
| Solvent | Tripropylene | 8% | 3% | | 3% |
| | glycol | | | | |
| | methyl | | | | |
| | ether | | | | |
| | (Dowanol | | | | |
| | TPM Dow | | | | |
| | Chemical) | | | | |
| Solvent | Ethylene | 5.50% | 6.50% | 9.50% | 6.50% |
| | glycol | | | | |
| Solvent | 1,2- | 2.00% | 2.00% | 2.00% | 2.00% |
| | Hexanediol | | | | |
| Humectant | Glycerol | | 5.00% | 6.00% | 6.00% |
| Surfactant | | 0.25% | 0.5% | 0.25% | 0.5% |
| | | BYK- | Surfynol | Surfynol | Surfynol |
| | | 348 | 440 | 440 | 440 |

Wt % (based on total weight of ink) BYK-348 (BykChemie) Surfynol 440 (Airproducts)
Table Footnotes
The polymeric binder was a crosslinked polyurethane (PUD EX2) in US20050182154.

### Printing Performance

Tests of the pretreatment solution and comparative tests were done by printing on jewel cases (containers for CDs or DVDs) and transparencies. For those tests marked with a dry coating the substrate was dried for about 5 minutes in an oven set at 70° C. The wet samples were printed within 20 seconds of putting the coating on the substrate. The inclusion of white ink in the process is also a variable. The DTG printer is not easily configured to print the white ink essentially simultaneously with the colored inks. 1 cm wide parallel lines of one color were printed on the substrates and observed. The printed images on the media were dried for about 15 minutes in an oven set at 70° C., and then the observations of the printing quality was noted.

TABLE 4
Printing Performance of Inventive and Comparative Inks

| | | Wet or | | | |
|---|---|---|---|---|---|
| Sam- | Pretreatment | Dry | Me- | White | |
| ple # | solution | coating | dia | ink | Comments |
| Ex 1 | Pretreat | Dry | Jewel | No | Slight bleed |
| | Solution 1 | | case | | between Red and |
| | | | | | Green, and cyan |
| | | | | | and magenta |
| Ex 2 | Pretreat | Wet | Jewel | No | Bleed equal to Ex |
| | Solution 1 | | case | | 1, color uniformity |
| | | | | | not as good as Ex 1 |
| Ex 3 | Pretreat | Dry | Jewel | First | Bleed equal to Ex 1 |
| | Solution 1 | | case | | good white and |
| | | | | | color uniformity |
| Ex 4 | Pretreat | Wet | Jewel | First | Bleed worse than |
| | Solution 1 | | case | | Ex 1 Good white |
| | | | | | and color uniformity |
| Ex 5 | Pretreat | Dry | Jewel | Last | Bleed better than |
| | Solution 1 | | case | | Ex 1 (shows |
| | | | | | variability across all |
| | | | | | of the color color |
| | | | | | interfaces) good |
| | | | | | white and color |
| | | | | | uniformity. |
| Ex 6 | Pretreat | Wet | Jewel | Last | Bleed equals Ex 1 |
| | Solution 1 | | case | | good uniformity |
| | | | | | with white and |
| | | | | | colors |
| Ex 7 | Pretreat | Dry | Jewel | Last | Pretreatment |
| | Solution 1 | | case | | applied with a # 6 |
| | | | | | coating rod; |
| | | | | | probably too much |
| | | | | | pretreatment for |
| | | | | | the substrate was |
| | | | | | applied. Ink |
| | | | | | cracking due to too |
| | | | | | much pretreatment |
| Ex 8 | Pretreat | Dry | Film | No | Bleed and |
| | Solution 1 | | | | uniformity equals |
| | | | | | Ex 1 |
| Ex 9 | Pretreat | Dry | Film | Last | Bleed better than |
| | Solution 1 | | | | Ex 1 (shows |
| | | | | | variability across all |
| | | | | | of the color color |
| | | | | | interfaces)) good |
| | | | | | white and color |
| | | | | | uniformity. |
| Comp | No | | Jewel | No | Color uniformity |
| Ex 1 | Pretreatment | | case | | very bad, hard to |
| | | | | | see bleed |
| Comp | Comp. | Dry | Jewel | No | Signficantly more |
| Ex 2 | Pretreat Soln 3 | | case | | bleed that Ex 1; all |
| | | | | | color pairs |
| | | | | | demonstrated |
| | | | | | bleed; colors are |
| | | | | | equal to Ex 1 |
| Comp | Comp. | Dry | Film | No | Bleed between |
| Ex 3 | Pretreat Soln 1 | | | | colors Equals Ex 1, |
| | | | | | bleed of cyan by |
| | | | | | itself very poor |
| Comp | Comp. | Dry | Jewel | No | Bleed equals Ex 1 |
| Ex 4 | Pretreat Soln 1 | | case | | but colors as not |
| | | | | | wetting as well |
| | | | | | poor color |
| Comp | Comp. | Wet | Jewel | No | Color uniformity |
| Ex 5 | Pretreat Soln 1 | | case | | very bad, hard to |
| | | | | | see bleed |
| Comp | Comp. | Dry | Jewel | First | Bleed equal to Ex 1 |
| Ex 6 | Pretreat Soln 1 | | case | | poor white |
| | | | | | uniformity; blotchy |
| | | | | | colored areas |
| Comp | Comp. | Wet | Jewel | First | Blead equal to Ex 1 |
| Ex 7 | Pretreat Soln 1 | | case | | poor white |
| | | | | | uniformity; blotchy |
| | | | | | areas but less than |
| | | | | | Comp Ex 6 |
| Comp | Comp. | Dry | Jewel | Last | Bleed worse than |
| Ex 8 | Pretreat Soln 1 | | case | | Ex 1 poor |
| | | | | | uniformity with |
| | | | | | white and colors. |
| Comp | Comp. | Wet | Jewel | Last | Difficult to measure |
| Ex 9 | Pretreat Soln 1 | | case | | bleed. Uniformity |
| | | | | | very bad for white |
| | | | | | and colors; very |
| | | | | | poor image |
| Comp | Comp. | Dry | Jewel | Last | Pretreatment |
| Ex 10 | Pretreat Soln 1 | | case | | applied with a # 6 |
| | | | | | coating rod; |
| | | | | | probably too much |
| | | | | | pretreatment for |
| | | | | | the substrate was |
| | | | | | applied. Poor bleed |
| | | | | | very poor |
| | | | | | uniformity |
| Comp | Comp. | Dry | Film | No | Bleed between |
| Ex 11 | Pretreat Soln 3 | | | | colors Equals Ex 1, |
| | | | | | bleed of cyan by |
| | | | | | itself very poor |
| Comp | Comp. | Dry | Film | Last | Bleed between |
| Ex 12 | Pretreat Soln 1 | | | | colors Equals Ex 1, |
| | | | | | bleed of cyan by |
| | | | | | itself very poor |

Comparative Examples 2 and 11 have multivalent cationic salts, acetylenic diol surfactants and significant amounts of organic solvents. The other Comparative Examples have multivalent cationic salts and significant amounts of organic solvents.

Example 1 shows that when compared to Example 2 drying of the media after the pretreatment and before the printing improves the image quality. Example 5 shows that when compared to Example 6 drying of the media after the pretreatment and before the printing improves the image quality. Example 1 when compared to Comparative Example 2 shows much better bleed, and in turn a better printed image. This shows that the either the acetylenic diol surfactant and/or the significant amount of organic solvents results in significantly inferior printed image results.

Tests of the pretreatment solution were also carried out on commercial offset paper, specifically Supreme Gloss (by Xerox) with the DTG printer. Similar pure color stripes were printed except the width of the stripe was 1.4 cm. The untreated paper printed at a 6 picoliter showed significantly blotches of color ink, significant bleeding between the black and yellow and black and orange. Paper pretreated with Treatment Solution #1 and oven dried for 5 minutes at 70° C. showed excellent bright colors with little bleed between the different colors. Similar test with inventive pretreatment with a 4 picoliter ink drop also produced similar good printing although the colors were not as vivid as the 6 picoliter drop—indicating that the ink drop size must be matched to the low/non porous substrate.

1. A method of digitally printing a non-porous or low porous media comprising:
(a) pretreating the non-porous or low porous media with a pretreatment solution comprising an aqueous multivalent cationic salt solution and a surfactant
(b) optionally, drying the pretreated low porous media,
(c) digitally printing the dried, pretreated non-porous or low porous media with a disperse dye or pigmented ink jet ink,
(d) where the pretreatment solution has substantially no organic species other than the surfactant and the surface tension of the pretreatment solution is about 15 dynes/cm to about 33 dynes/cm.

2. The method of claim 1, wherein the multivalent cation is selected from one or more of the group of multivalent cations of elements Mg, Ca, Sr, Ba, Sc, Y, La, Ti, Zr, V, Cr, Mn, Fe, Ru, Co, Rh, Ni, Pd, Pt, Cu, Au, Zn, Al, Ga, In, Sb, Bi, Ge, Sn and Pb.

3. The method of claim 1, wherein the multivalent cation is calcium.

4. The method of claim 3, wherein the pretreatment solution comprises a solution of a multivalent cationic salt in water, wherein the multivalent cationic salt is selected from the group consisting of calcium chloride, calcium chloride hydrate and mixtures thereof.

5. The method of claim 1, wherein the pretreatment solutions comprises a solution of multivalent cation solution of about 5 wt % to about 70 wt % multivalent cation weighed as the total weight of the salt added to the solution.

6. The method of claim 1, wherein the surface tension of the pretreatment solution is about 18 dynes/cm to about 30 dynes/cm.

7. The method of claim 1, wherein the pretreatment solution comprises a solution of surfactant of about 0.1 wt % to about 10 wt % surfactant weighed as the total weight of the surfactant solution added to the solution.

8. The method of claim 1, wherein the pretreatment solution comprises a solution of surfactant of about 0.25 wt % to about 8 wt % surfactant.

9. The method of claim 1, wherein the pretreatment solution comprises a solution of surfactant of about 0.5 wt % to about 5 wt % surfactant.

10. The method of claim 1, wherein the pretreatment solution comprises a solution of surfactant selected from the group consisting of fluorosurfactants, siloxane surfactants, and mixtures thereof.

11. The method of claim 1, wherein the pretreatment solution is substantially free of other added organic components.

12. The method of claim 1, wherein the non-porous or low porous media is colored, and the white pigmented inkjet ink is printed onto the colored non-porous or low porous media as a background for an image.

13. The method of claim 1, wherein the non-porous or low porous media is printed with a white pigmented inkjet ink.

14. The method of claim 1, wherein the non-porous or low porous media is printed with a pigmented inkjet ink set comprising at least two differently colored pigmented inkjet inks.

15. The method of claim 14, wherein at least one of the pigmented inkjet inks is white.

16. The method of claim 14, wherein the inkjet ink set comprises at least three differently colored pigmented inkjet inks, wherein at least one is a cyan pigmented inkjet ink, at least one is a magenta pigmented inkjet ink, and at least one is a yellow pigmented inkjet ink.

17. The method of claim 15 or claim 16, wherein the inkjet
ink set further comprises a black pigmented inkjet ink.

18. The method of claim 14, wherein the pigmented inkjet ink comprises an anionically stabilized pigment in an aqueous vehicle.

19. The method of claim 14, wherein the pigmented inkjet individually comprise, a polymeric binder.

20. The method of claim 19, wherein the polymeric binder comprises a crosslinked polyurethane.
